(19) United States
(12) Patent Application Publication
(10) Pub. No.: US 2013/0179804 A1
(43) Pub. Date: Jul. 11, 2013

(54) MAP-BASED SOCIAL GROUP METHOD AND SYSTEM

(71) Applicant: He Kang, West Bloomfield, MI (US)

(72) Inventor: He Kang, West Bloomfield, MI (US)

(21) Appl. No.: 13/737,136

(22) Filed: Jan. 9, 2013

Related U.S. Application Data
(60) Provisional application No. 61/584,872, filed on Jan. 10, 2012.

(51) Int. Cl. G06F 3/0481

(52) U.S. Cl. CPC G06F 3/04817
USPC 715/756

(57) ABSTRACT

A method of connecting a first party having a computer device with a second party having a computer device using a virtual computer network. The current geographical location of the first party and the second party is determined using a global positioning system. A map of the vicinity of the geographical location of the first party on the computer device of the first party is displayed. A virtual computer network group created by the first party that can be joined by a second party is established. A first icon is displayed on the map of the first party computer device and on the second party computer device located within a predetermined distance from the first party. The first icon indicates in real-time the virtual computer network group created by the first party. The second party joins the virtual computer network group created by the first party if the second party selects to do so. A virtual computer network group can also be created by the second party and established and displayed in a similar manner so that the first party can join it.

Claim Benefits of Provisional application 61/584,872 with the same title filed on Jan. 10, 2012

### BACKGROUND

The present disclosure relates generally a mobile device application, and more particularly, to a map-based social group application that utilizes geo-location to specify the near realtime location of a user and enables the user to create and/or join an “on-the-spot” networked virtual group that can be accessed by another user of the application within a limited geographical radius. The present disclosure also relates to a system by which a user, who establishes, maintains, and manages the application, provides another user with the services of creation and authentication of the virtual group. This invention solves the conflict between privacy concern and better user experience that demands more accurate location integration in modern mobile devices. It also tackles the “lack of structure” problem on how applications reside in a mobile device, by utilizing easy-to-access map.

### DESCRIPTION OF THE RELATED ART

The proliferation of social networks in recent years has allowed persons to keep in touch with acquaintances through computers and mobile devices. Opportunities to interact with unknown persons through computer-based applications, however, have been limited.

Thus, there is a need in the art for a method and system for connecting and interacting with unknown persons within a geographical location.

### SUMMARY

Accordingly, a method of connecting a first party having a computer device with a second party having a computer device using a virtual computer network is provided. The current geographical location of the first party and the second party is determined using a global positioning system. A map of the vicinity of the geographical location of the first party on the computer device of the first party is displayed. A virtual computer network group created by the first party that can be joined by a second party is established. A first icon is displayed on the map of the first party computer device and on the second party computer device located within a predetermined distance from the first party. The first icon indicates in real-time the virtual computer network group created by the first party. The second party joins the virtual computer network group created by the first party if the second party selects to do so. A virtual computer network group can also be created by the second party and established and displayed in a similar manner so that the first party can join it.

An advantage of the present disclosure is that an individual located within a geographical location can connect and interact with other like-minded users located within the same geographical location.

Other features and advantages of the present disclosure will be readily appreciated, as the same becomes better understood in view of the subsequent description taken in conjunction with the accompanying drawings.

### BRIEF DESCRIPTION OF THE DRAWINGS

FIG. 1 is a diagram illustrating a screen view showing an initial screen displayed on a mobile device, according to an exemplary embodiment.

FIG. 2 is a diagram illustrating a screen view showing a profile screen that is displayed on a mobile device, according to an exemplary embodiment.

FIG. 3 is a diagram illustrating a screen view showing a main map screen that is displayed on a mobile device, according to an exemplary embodiment.

FIG. 4 is a diagram illustrating a screen view showing the main map screen of FIG. 3 with additional information appearing on the map screen, according to an exemplary embodiment.

FIG. 5 is a diagram illustrating a screen view showing an example of a group discussion screen that is displayed on a mobile device, according to an exemplary embodiment.

FIG. 6 is a diagram illustrating a screen view showing an example of a group creation screen that is displayed on a mobile device, according to an exemplary embodiment.

FIG. 7 is a diagram illustrating a screen view showing an example of an establishment information screen that is displayed on a mobile, according to an exemplary embodiment.

### DESCRIPTION

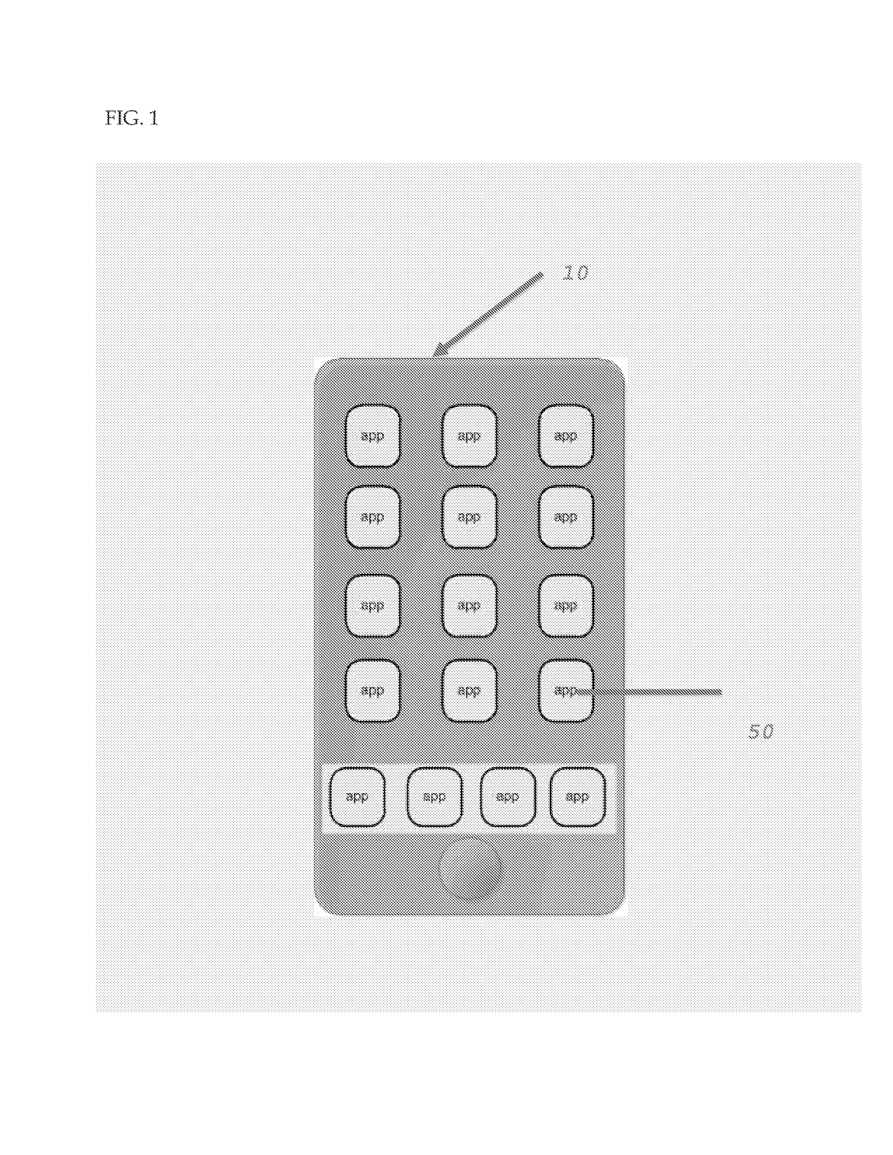

Referring to generally to FIGS. 1 through 7, a computer device is shown. In this example the computer device is a mobile device 10. The mobile device includes a processor, a memory, a display and an input mechanism, and a transceiver for communicating with another device over a communications network. The mobile device 10 can contain a locating function, such as GPS, or the like.

The mobile device may also have an energy-saving feature that reduces the amount of consumption of battery power as described hereinafter. The energy-saving feature may determine if the time intervals at which the application obtains the current location of the user from GPS is short, more power is consumed and the battery life is shortened. Accordingly, energy-saving feature lengthens the time interval at which the current location is “fetched” or retrieved when it is considered that the user is remaining in given location.

For example, T1 is the initial time interval at which the current coordinates of the mobile device are retrieved. For example, T1 can be 10 seconds. The initial coordinates at the start-up of the application are X1, the coordinates obtained 10 seconds later are X2, the coordinates obtained 10 seconds after the obtaining of coordinates X2 are X3, . . . , etc. Each time the current coordinates are obtained, the distance between those coordinates and the immediately preceding ones is computed. In other words, distances DX2−X1, DX3−X2, DX4−X3, . . . are computed. The distance is compared with a predetermined threshold value to determine whether the mobile device is moving or in a relatively stationary state. If the distance is less than the predetermined threshold value a given number of predetermined consecutive times, such as 3 times, or the like, it is judged that the mobile device is relatively stationary, and the coordinate retrieving interval T1 is increased to T2, for example, 1 minute. Here again, distances between current coordinates and immediately previous coordinates are computed and compared with a predetermined threshold value, and the retrieving interval is increased when it is judged that the distance is less than a threshold value a given number of consecutive times. This process may be repeated and the coordinate retrieving interval lengthened until a maximum fetching interval Tmax is reached. If, at any time, it is judged that the computed distance exceeds the threshold value, the retrieving interval is restored to the initial (non-lengthened) time interval T1. In this way, when the user is not traveling and the mobile device is judged to be relatively stationary (e.g., the user is sitting in a café rather than traveling in a car), the time interval at which the current coordinates of the mobile device are retrieved is lengthened so as to reduce the amount of battery power consumption.

The mobile device of this example includes an application 50 for creating and maintaining a virtual network that enables a party, such as an individual user, multiple users, an establishment user, or the like, located within a predetermined geographical location to join a network group and interact with one another. Application 50 may be stored in the memory associated with the processor.

While the method and system is described in terms of an individual or an establishment user all types of users are contemplated. While a mobile device is shown, it is contemplated that the computer device can be any variety of computer devices including a laptop, PDA, cell phone, smart phone, or the like.

The group communication system employing the mobile device 10 and application 50 can be used in a variety of ways. For example: (1) a user can create a network group that other parties can join; (2) a user can join a network group created by another party; or (3) an establishment user can create a network group that other parties can join. The group communication system can be used in conjunction with other features involving authentication, security, registration, or the like. For example, the network group created by an establishment user may be registered so as to be authenticated as having definitely been created by the establishment user.

A user desiring to use the application 50 downloads and installs it in their mobile device 10. The mobile device 10 utilizes a locating function, such as GPS, or the like, to identify the present location of the user.

When the application 50 is enabled, a map screen (based on Google Maps for example) is displayed on the display screen associated with the mobile device. This map screen shows, as an icon, the current geographical location of the user in real-time, as well as icons of other users who have enabled the application, and icons of groups created by individual users or establishment users of the application.

The system includes a group, which may be displayed on the display screen. If a group is of interest to the user, the user touches that icon, obtains further information regarding the group, and can choose to join the group. A group may be password protected, in which case, the user would be prompted to enter the password in order to join the group.

A user that is an individual or group of individuals may choose to create a group to, for example, invite messaged conversation centering on a topic of interest. The group can be joined by any other nearby users located in a predetermined geographical location who are utilizing the application. The group can be established for a predetermined duration of time if desired. For example, the user who creates the group can set an expiration period for the group. Alternatively, the system can set a default expiration time.

Any establishment, such as a restaurant, café, store, house of worship, salon, supermarket, gym, or the like, may own their own group. The establishment group may simply provide information regarding the establishment, or may more actively promote the activities, specials, sales, etc. thereof In addition, within their proffered group display, the establishment can include discussion groups centering on certain subjects. For example, a bar may provide a sports group and a politics group; a gym can have a kickboxing discussion group, or the like. Further, the establishment group can be customized to provide all kinds of features and capabilities.

The system may also include a centralized registration party that may control certain activities associated with the groups. For example, in order for an establishment to prove that a group they own is in fact a “legitimate” group owned by that establishment, the establishment can register their group with the centralized registration party (hereinafter called “managing company”). The managing company provides and manages the application, which can then provide an icon that authenticates the group as a verified group and is displayed within the establishment screens owned and proffered by the establishment.

The managing company can offer templates that establishments can use to create establishment group display screens by themselves and can also provide the service of creating establishment group display screens for establishments. For example, for establishments wishing to create their own group screens, the managing company provides various templates having different levels of sophistication of group functions, and different features, capacities, or the like, thereby enabling the company to charge different levels of fees (price discrimination) for the different templates and services.

A method of utilizing the mobile device within the group communication system is provided. It should be noted that these examples, and the examples shown in the drawings, are for illustration purposes only, and that the method and system is not to be limited thereto.

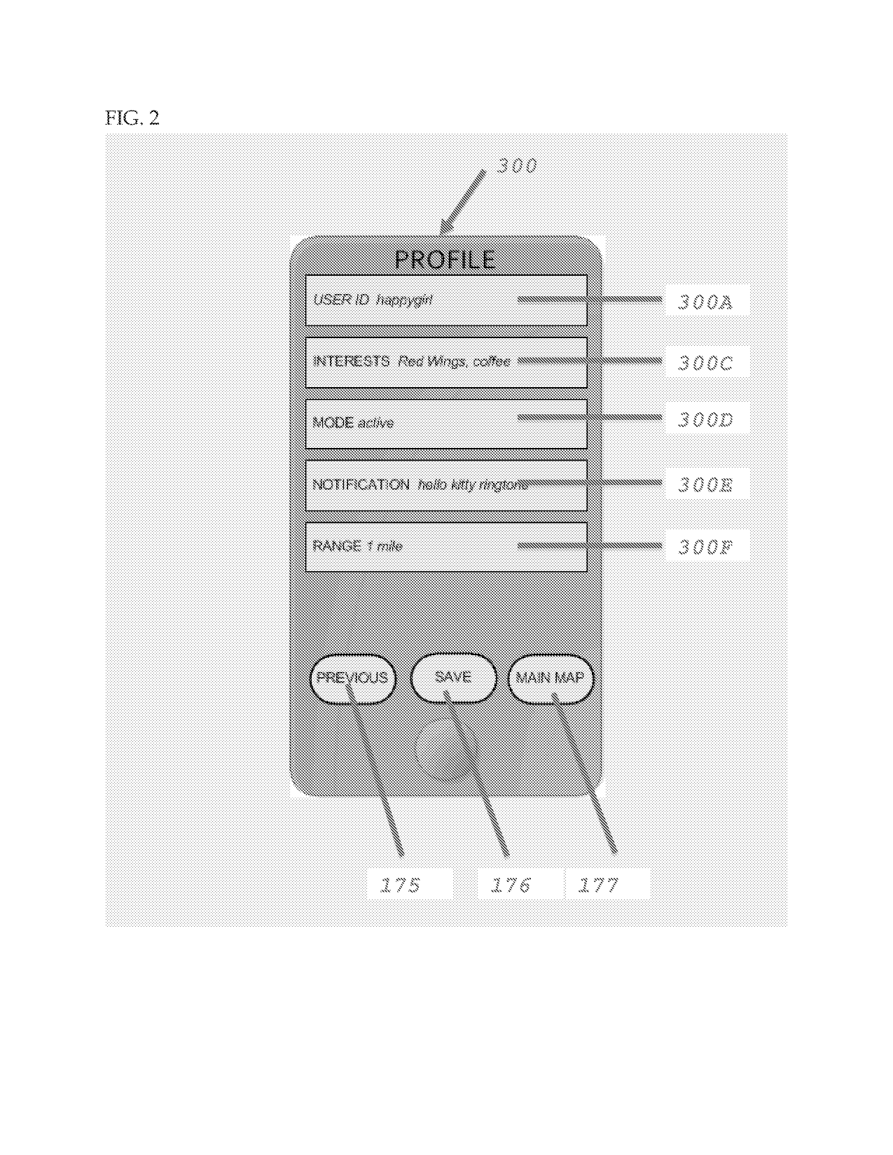

The method begins with the step of a user initialing setting up the application. For example, the user downloads the application and installs it in the mobile device 10 as previously described. The methodology advances to the next step of a user providing an input using an input device. For example, the user touches the application icon 50 on the screen of the mobile device 10 for the first time after download, and the application starts-up and first displays a profile screen 300, as shown in FIG. 2. The profile screen 300 may include various features, such as a user ID box 300A, an interests box 300C, a mode box 300D, a notification box 300E, and a range box 300F. The profile screen 300 may also include a previous button 175 that is touched to return to the previous screen, a save button 176 that is touched to save the settings that have been set within the screen, and a main map button 176 that is touched to return to the main map screen 100. Other screens within the application can also, as needed, include the previous button 175, the save button 176, the main map button 177, as well as a “profile” button 177 that is touched to return to the profile screen 300, and a “create” button 178 that is touched to move to a group creation screen 410 to be described in further detail below.

For example, by touching the user ID box 300A, a screen appears on the device 10 enabling the user to set how he/she wishes to identify himself to other users of the application. Here, the user can set a character string, upload a photo, select a graphic to be used as an icon, or use some combination thereof.

In another example, by touching the interests box 300C, a screen appears on the device 10 allowing the user to set interests and locations for which he/she wishes to be notified that groups have been established therefore or thereat. The user may select “all” in order to be notified of all groups that are established within the geographical range shown on the main map screen 100, or may limit the interests and locations to a particular interest and/or location such as “sports, “politics”, “dating”, “sales”, “cafes”, “restaurants”, “bars”, “clothing stores”, “grocery stores”, “bookstores”, or the like so that the user will only be notified of groups relating to the user's preferred interests and/or in certain locations. Regardless of the user's setting in the interests box 300C, all of the icons 150, 151 existing within the geographical range of the main map screen 100 may be displayed on the main map screen 100. Notification, however, is given, by a means to be described in further detail below, of only those groups matching the user's interests as set through this interests box 300C. In this sense, the interests box 300C can be considered to be a filter to narrow down, in accordance with the user's interests, the number of groups that the user is notified of.

In another example, by touching the mode box 300D, a screen appears on the device 10 enabling the user to set the mode of the application among inactive wherein the application is not operating and active wherein the application is operating. An icon, such as a self-icon, 125 denoting the user appears on the map, and the user can receive notifications; and stealth wherein the application is operating, but the self-icon 125 denoting the user is displayed differently, such as in grey, or the like, on the user's map and is invisible in maps on other users' screens.

In still a further example, by touching the notification box 300E, a screen appears on the device 10 enabling the user to set the form by which the user may be notified of the existence of a group or the creation of a new group, that corresponds to the user's settings, within the specified geographical range. The form may be any of icons 150, 151 of the groups flashing on the main map screen 100, the mobile device 10 vibrating, the mobile device 10 emitting a sound, or the like, or any combination thereof The icons 150 may represent groups created by individual users, and the icons 151 represent groups owned by establishments, to be described in further detail below.

In still a further example, by touching the range box 300F, a screen appears on the device 10 allowing the user to set the geographical range over which he/she wishes to be notified that groups exist. The range may be a radius expressed by a numerical figure, such as 500 feet, one mile, or the like, or a location, such as a city, a state, or the like, or the user may chose to limit the range to the range that is illustrated on the main map screen 100 displayed on the device 10.

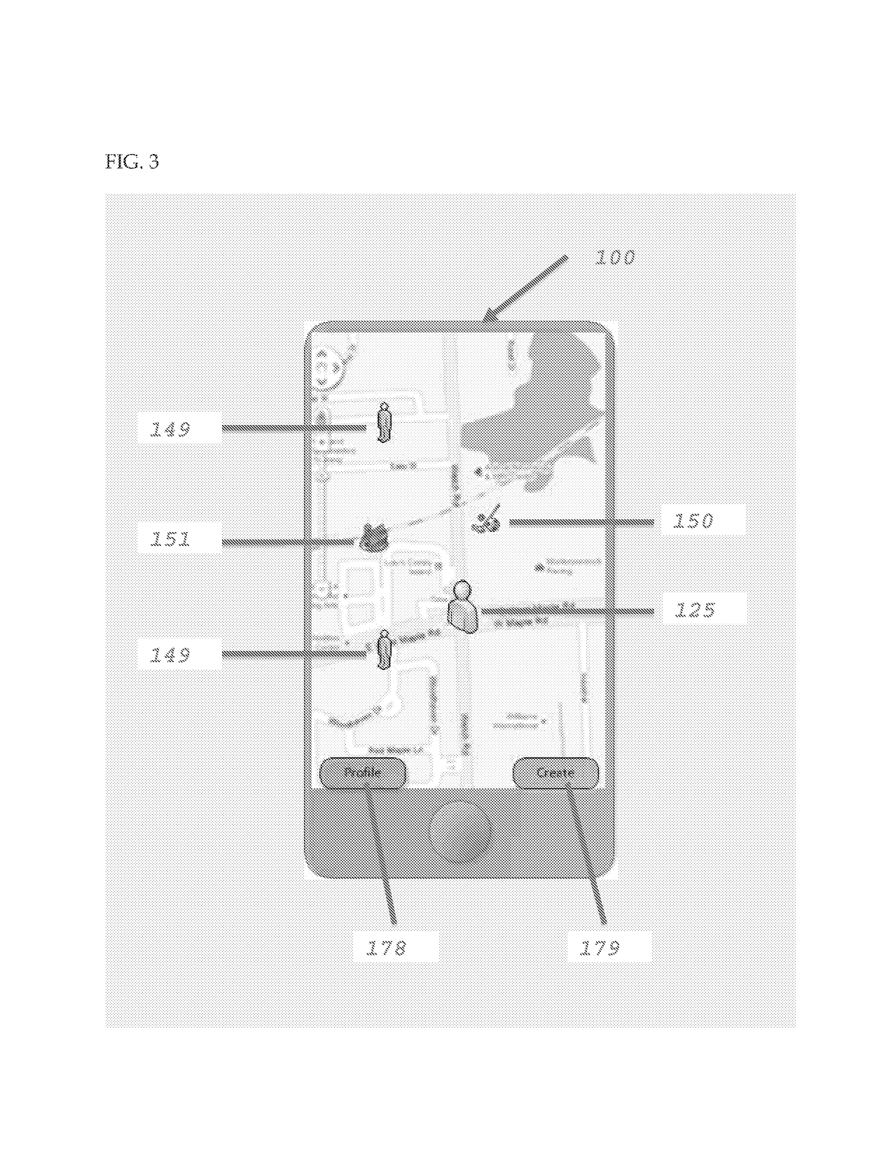

The methodology advances to the next step, and the user saves the settings. For example, after completing input of the settings of boxes 300A through 300F, the user touches the save button 176 to save the settings, either as the current setting or as a profile for future use, and the screen switches to the main map screen 100, as shown in FIG. 3, where the user's self-icon 125 and the icons 150, 151 representing the groups corresponding to the user's settings are displayed.

As previously described, the icons 150 corresponding to groups that have been established and are currently still in existence (have not expired) are displayed on the main map screen 100. In addition, the user can change settings and save settings at any time.

The methodology advances to the next step, and engages an “active” mode. For example, the user has the application set (through the mode box 300D) to active mode in which the application is actively operating. When the user turns the application on, the main map screen 100 is displayed on the mobile device (FIG. 3). This main map screen 100 displays the geographical location of the user. For example, the user geographical location may be displayed as the self-icon 125. The current geographical location of the user in real-time, as well as the icons 150 of groups created by any other individual users, and the icons 151 of groups owned by establishments/businesses may also be displayed. Icons 149 denoting other individual users of the application who are within that radius may also displayed. As the location of the user moves, the position of the self-icon 125 and the display range change in accordance therewith.

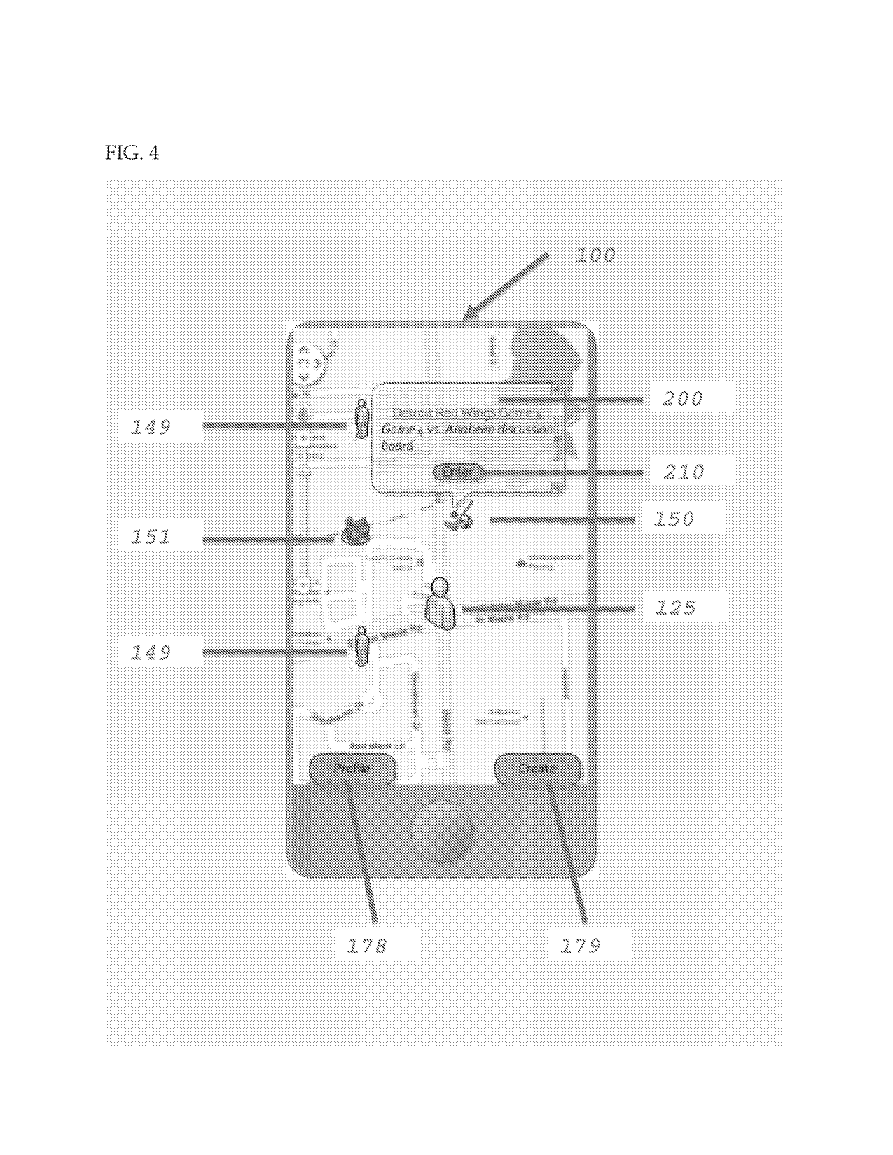

The methodology advances to the next step, and the user accesses an individually created group. For example, the user touches the icon 150 corresponding to that group. An information bubble 200 may appear on the main map screen 100, and includes basic information regarding the group, as shown in FIG. 4. If the user finds the displayed content of a group to be of interest, the user may touches an enter button 210 within the information screen 200 to join the group.

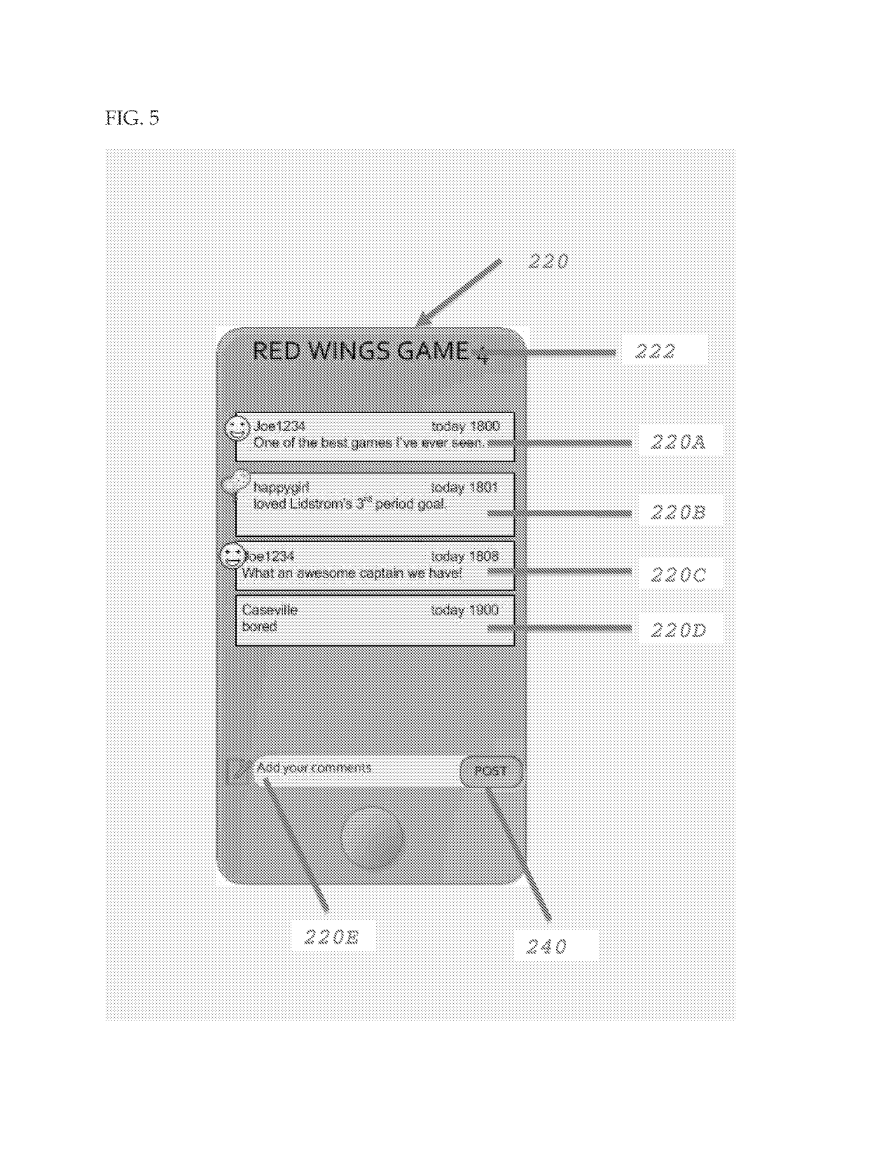

The methodology advances to the next step, and the display changes to a group discussion screen 220, as shown in FIG. 5. The group discussion screen 220 includes a discussion title 222 in which the comments of the participants in the group are listed and updated in real-time such as in comment boxes 220A, 220B, 220C, 220D. In an example, the group can be considered to be a chat group or a conversation group. The comment may be prefaced by the name/icon/avatar, or the like, that the user has chosen to represent himself/herself, such as Joe1234 in comment box 220A, for example. A time stamp showing the date and time that the comment was made or posted, such as today 1800 in comment box 220A may be included. At the bottom of the screen, a new comment box shown at 220E may be provided. The individual may input a comment by selectively typing within the new comment box 220E. The user may share the comment. For example, the user may activate a post button 240 to share the comment with the group. The comment will then move up within the group discussion screen 220 and be posted as the latest of the comments within the group discussion screen 220.

The methodology advances to another step, and an individual creates a group. The user begins by selecting a “create” option. For example, the main map screen 100 may have a create button 178 displayed therein. The methodology advances to the next step, and creates the group. For example, the user indicates where the user would like the group to be created by tapping a specific geographic location on the main map screen 100. By scrolling over the main map screen 100, the user can move the currently displayed geographical range, and can thereby set up a group that is not in the “immediate vicinity” of the user. However, that range, from the current position of the user, within which the user can set up a group is limited to a value set by the managing company the application. In this way, for example, a user in Chicago may be able to set up a group within the nearby Chicago suburban area, but cannot set up a group within New York.

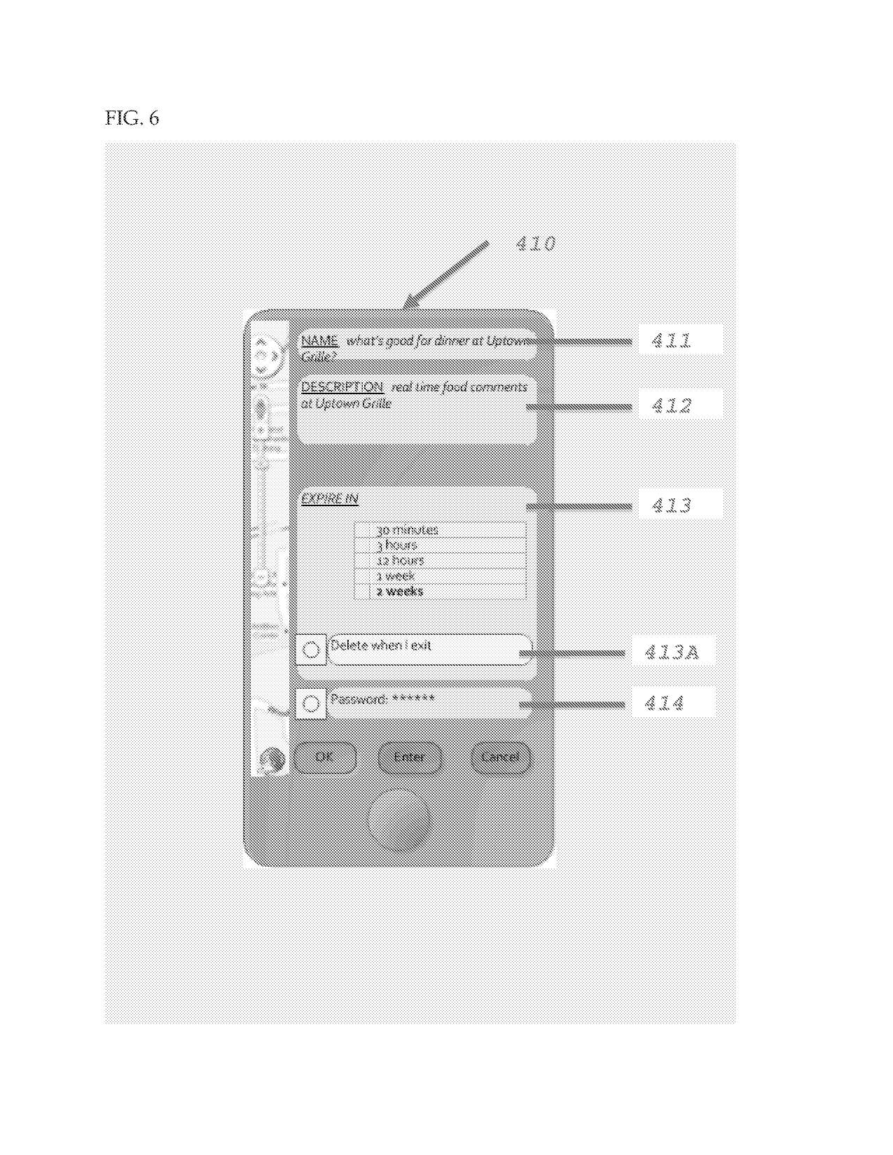

The user may be able to selectively move between different screens. For example, by tapping a specific location on the main map screen 100, the display may change from the main map screen 100 to the group creation screen 410, as shown in FIG. 6. The group creation screen 410 may include a title box 411 in which the group creator enters the title/name of the group, such as “Red Wings playoffs”, “what's good for dinner here?”, “US in Afghanistan”, “Scott's 10 AM aerobics class”, “lookin 4 luv”, “garage sale,” or the like. The name/title may be utilized as the discussion title 222 in the group discussion screen 220 shown in FIG. 5. The group creation screen 410 may also include other options, such as a description box 412 briefly describing the topic, an expiration box 413 in which the group creator enters the time the group is to expire which may be in the form of input, or in the form of tick-off boxes with options such as “one hour”, “one day”, or the like. The group creation screen 410 can also include other features such as a radio button 413A to enable the group to be deleted when the creator departs from the immediate vicinity, and a password box 414 for the creator to enter a password should he/she wish the group to be password protected and accessible by only those with whom the password is shared. Still another feature is an “ok” input button as shown at 420, and activating causes the group icon 150 be displayed on the main map screen 100. Another features is an enter button 421 which the creator utilizes to switch the display to the group discussion screen 220 and the user inputs the initial comment in the group discussion. The screen may also includes a cancel feature as shown at 422 that cancels the current group creation screen 410 and returns display to the main map screen 100.

It is to be noted that groups do not have to be in the form of a chat/conversation and can merely be in the form of a notice that is posted on the main map screen 100. For example, such as in the case of providing notification of an estate sale, an open house, an organization's cookie sale, or other event.

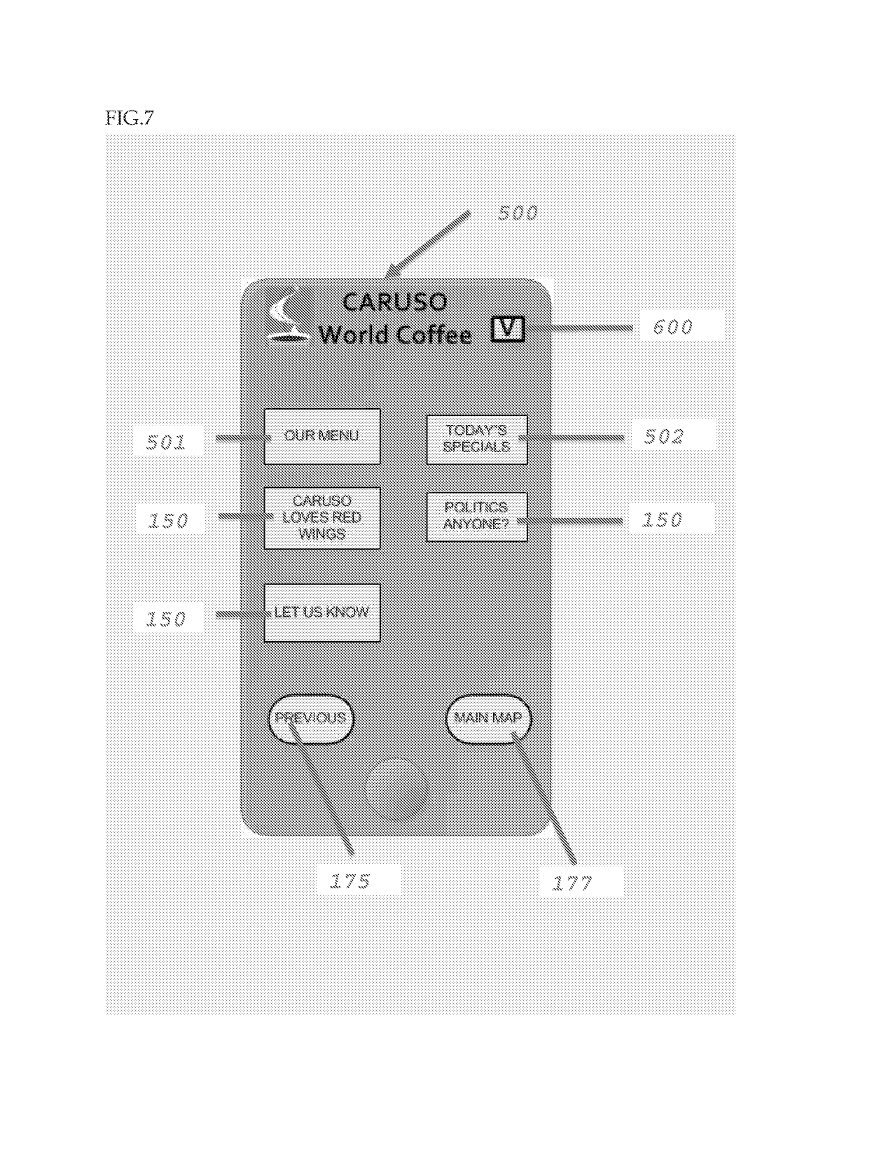

The methodology advances to the next step and an establishment sets up a group. In anticipation of the more complex needs of establishments to provide information to potential clients, a group that is owned by an establishment may be a more complex display. For example, the establishment may chose to have the icon 151 of their establishment group direct the user who activates the icon 151 to an establishment information screen 500, as shown in FIG. 7, that provides, for example, information regarding the establishment, rather than the aforementioned group discussion screen 210 that merely provides a forum for comments.

In an example of an establishment which is a café, the establishment information screen 500 may be designed to include a (food/beverage) menu button 501 and a user may activate to view the café's menu in another screen. Other options include a today's specials button 502 which a user presses to view the specials of the day in another screen, and the icons 150 of discussion groups created by the café for their patrons to join in. In this example, the discussion groups include one relating to sports, one relating to politics, and one for customers to discuss the café, thereby providing feedback to the establishment. When a user presses the icon 150 within the establishment information screen 500, the group discussion screen 220 such as that shown in FIG. 5, is displayed on the user's mobile device.

It should be noted that, although a user can engage in the chatting within discussion groups owned by an establishment and displayed in the establishment's establishment information screen 500, users can be prevented from editing the contents included within displayed screens that are owned by establishments.

The establishment group may include a feature that enables the user to verify that the establishment group is in fact a “legitimate group” owned, proffered and sanctioned by the establishment. Thus, the establishment may register the group with a management company who will then provide the establishment with a verification icon 600, as shown in see FIG. 7, that can be displayed in all displayed pages of the establishment group.

The establishment group screen may include other features, such as to start-up a new application provided by the establishment (an “app-within-an-app”), or the like. The establishment information screen 500 and sub-screens may be owned by the establishment after being purchased from the managing company. In this case, “subscreens” are screens that are displayed when a user touches any of the icons, such as 501, 502, 150, as shown in FIG. 7, existing within the establishment information screen 500. The managing company can offer templates that establishments can use to create their own group displays.

The steps of the methodology may be selectively performed in any order.

Many modifications and variations of the present disclosure are possible in light of the above teachings. Therefore, within the scope of the appended claim, the present disclosure may be practiced other than as specifically described.

What is claimed is:

1. A method of connecting a first party having a computer device with a second party having a computer device using a virtual computer network, the method comprising the steps of:
determining the current geographical location of the first party and the second party using a global positioning system;
displaying a map of the vicinity of the geographical location of the first party on the computer device of the first party;
establishing a virtual computer network group created by the first party that can be joined by a second party;
displaying a first icon on the map of the first party computer device and on the second party computer device located within a predetermined distance from the first party, the first icon indicating in real-time the virtual computer network group created by the first party; and
joining the second party to the virtual computer network group created by the first party if the second party selects to do so.

2. The method of claim 1, further comprising the step of:
establishing a virtual computer network group created by the second party that can be joined by a first party;
displaying a second icon on the map of the second party computer device and on the first party computer device located within a predetermined distance from the second party, the second icon indicating in real-time the virtual computer network group created by the second party; and
joining the first party to the virtual computer network group created by the second party if the first party selects to do so.

3. The method of claim 1, wherein at least one of the first party computer device and the second party computer device is one of a mobile device, smart phone, PDA, and laptop.

4. The method of claim 1, wherein the first party can set virtual computer network group parameters relating to the virtual computer network group the first party created and the second party can set virtual computer network group parameters relating to the virtual computer network group the second party created.

5. The method of claim 4, wherein the virtual computer network group parameters include setting the virtual computer network group so that it is one of opened, closed, public, and private.

6. The method of claim 1, wherein the first party can set map display parameters relating to the map displayed on their computer device and the second party can set map display parameters relating to the map displayed on their computer device.

7. The method of claim 6, wherein the map display parameters include setting the type of virtual computer network groups to display based on interest and location.

8. The method of claim 7, wherein the location coincides with a selected geographical radius.

9. The method of claim 1, wherein the virtual computer network group is customized to correspond to a selected topic including at least one of sports, politics, dating, sales, cafes, restaurants, bars, clothing stores, grocery stores, bookstores.

10. The method of claim 1, wherein joining the virtual computer network group requires logging in with a password and ID.

11. The method of claim 1, wherein the virtual computer network group is registered for security and authentication.

12. A system for connecting a first party with a second party using a virtual computer network, the system comprising:
a first mobile computer device of a first party in operative communication with the virtual computer network;
a second mobile computer device of a first party in operative communication with the virtual computer network
a global positioning system that determines the current geographical location of the first party and the second party;
wherein the mobile computer device of the first party displays a map of the vicinity of the geographical location of the first party;
wherein the virtual computer network establishes a virtual computer network group created by the first party that can be joined by a second party;
wherein the first mobile computer device displays a first icon on the map of the first party mobile computer device and on the second party mobile computer device located within a predetermined distance from the first party, the first icon indicating in real-time the virtual network group created by the first party; and
wherein the virtual computer network joins the second party to the virtual computer network group created by the first party if the second party selects to do so.

13. The system of claim 10, wherein the virtual computer network establishes a virtual computer network group created by the second party that can be joined by a first party;
wherein the second mobile computer device displays a second icon on the map of the second party mobile computer device and on the first party mobile computer device located within a predetermined distance from the second party, the second icon indicating in real-time the virtual network group created by the second party; and
wherein the virtual computer network joins the first party to the virtual computer network group created by the second party if the first party selects to do so.

14. A method of providing a service to users of mobile devices, the service comprising:
displaying a map of a vicinity of a current location of a user of the service on a mobile device of the user, by using location-based services;
providing a function for the user to create a virtual group to be indicated on the map of the vicinity;
displaying, on the map and in real-time, virtual groups that are created by the user and other users of the service and that exist within the vicinity of the current location of the user; and
providing a function for the user to join virtual groups that are created by the other users and are indicated on the map of the vicinity.
